(19) United States
(12) Patent Application Publication
(10) Pub. No.: US 2017/0154561 A1
(43) Pub. Date: Jun. 1, 2017

(54) ARRAY SUBSTRATE AND THE DRIVING METHOD THEREOF

(71) Applicant: Shenzhen China Star Optoelectronics Technology Co. Ltd., Shenzhen, Guangdong (CN)

(72) Inventors: Tao HE, Shenzhen, Guangdong (CN); Yu-yeh CHEN, Shenzhen, Guangdong (CN); Jhen-wei HE, Shenzhen, Guangdong (CN)

(73) Assignee: Shenzhen China Star Optoelectronics Technology Co. Ltd., Shenzhen, Guangdong (CN)

(21) Appl. No.: 14/785,835

(22) PCT Filed: Sep. 9, 2015
(86) PCT No.: PCT/CN2015/089219

§ 371 Date: Oct. 20, 2015

(30) Foreign Application Priority Data
Aug. 26, 2015 (CN) 201510532056.6

(51) Int. Cl. G09G 3/20; G02F 1/1362; G02F 1/1335; G09G 3/36

(52) U.S. Cl. CPC G09G 3/2074; G09G 3/3677; G09G 3/3688; G09G 3/3696; G09G 3/2003; G02F 1/136286; G02F 1/133514; G02F 1/133512; G09G 2320/0646; G09G 2320/0666

(57) ABSTRACT

An array substrate and the driving method are disclosed. The array substrate includes a plurality of scanning lines arranged along a row direction, a plurality of data lines arranged along a column direction, and a plurality of sub-pixels arranged in a matrix defining by the scanning lines and the data lines. The sub-pixels are divided into a plurality of sub-pixel rows of different colors arranged periodically along the column direction, wherein at least one sub-pixel row is a compensation photon sub-pixel row. Within the same frame, a driving voltage polarity of two adjacent data lines of the compensation photon sub-pixel row is opposite to each other. In this way, the brightness change is decreased so as to enhance the image quality.

### BACKGROUND OF THE INVENTION

1. Field of the Invention

The present disclosure relates to liquid crystal display technology, and more particularly to an array substrate and the driving method thereof.

2. Discussion of the Related Art

Compared with liquid crystal panel having conventional RGB pixel structure, W sub-pixel (white pixel) has been added to the pixel structure having RGBW pixel structure to obtain higher transmission rate. This not only reduces the power consumption of the backlight, but also the cost.

As shown in FIG. 1, the liquid crystal panel having conventional RGBW pixel structure includes R sub-pixel, G, sub-pixel, B sub-pixel and W sub-pixel arranged along a column direction in turn. The scanning lines (G1-Gn) are arranged along a row direction, and data lines (D1-Dm) are arranged along the column direction. Each of the sub-pixel is defined by one scanning line (G) and one data line (D). Usually, the liquid crystal panel is driven by a row inversion method. When such driving method is adopted, after one scanning period and before the next scanning period, the voltage polarity stored by the sub-pixels in the same row are the same and the voltage polarity stored in the sub-pixels in two adjacent row are opposite to each other, with respect to the panel having the RGB pixel structure. Within the RGB pixel structure, each of the pixel cells includes three RGB sub-pixels, which is odd. Thus, when the pixel cells on the same column are driven, the voltage polarity of two adjacent sub-pixels of the same type is also opposite to each other. Thus, the coupling effect caused by the sub-pixels of the same type toward the common electrode may be offset, which greatly reduce the horizontal crosstalk of the liquid crystal panel.

With respect to the liquid crystal panel having RGBW pixel structure, in the column direction, the voltage polarity of the RGBW sub-pixels of two adjacent pixel cells may be a mirror image. As shown in FIG. 1, the sub-pixel row driven by the scanning line (G1), the voltage polarity of the RGBW sub-pixels respectively connected by the data lines (D1-D4) are respectively +, −, +, and −, and the voltage polarity of the RGBW sub-pixels respectively connected by the data lines (D5-D8) are respectively −, +, −, and +. Thus, the voltage polarity of the two adjacent sub-pixels of the same type are opposite to each other so as to reduce the coupling effect and the horizontal crosstalk.

Regarding the above pixel structure, each of the sub-pixels are between the two data lines. As shown in FIG. 2, taking the sub-pixel (W) connected by the data line (D4) as one example, the parasitic capacitance (Cp1) exists between the pixel electrode of the sub-pixel (W) and the data line (D4), and the parasitic capacitance (Cp2) exists between the pixel electrode (Pw) of the sub-pixel (W) and the data line (D5). When being driven, the voltage polarity of the sub-pixels (W) and (R) are the same, the polarity of the two adjacent data lines (D4, D5) of the sub-pixel (W) are the same such that the capacitance coupling effect caused by the data line toward the pixel electrode of the sub-pixel (W) becomes stronger. As such, the voltage of the pixel electrode of the sub-pixel (W) is changed, which generates the vertical crosstalk and changes the brightness of the sub-pixel (W). Usually, the sub-pixel (W) is shown as white so as to compensate the brightness of the images. Thus, the grayscale change of the sub-pixel (W) may cause a larger brightness change, which may be easily detected by human eyes and thus the display performance may be affected.

### SUMMARY

The present disclosure relates to an array substrate and the driving method thereof to reduce the brightness change of the images so as to enhance the image quality.

In one aspect, an array substrate of liquid crystal panels includes: a plurality of scanning lines arranged along a row direction, a plurality of data lines arranged along a column direction, and a plurality of sub-pixels arranged in a matrix defining by the scanning lines and the data lines, the scanning lines and the data lines correspond to the black matrixes of a color film substrate of the liquid crystal panel, the sub-pixels are divided into a plurality of sub-pixel rows of different colors arranged periodically along the column direction, wherein at least one sub-pixel row is a compensation photon sub-pixel row, within the same frame, a driving voltage polarity of two adjacent data lines of the compensation photon sub-pixel row is opposite to each other, and within the same frame, the driving voltage polarity of each of the sub-pixel rows within each arranging periods is opposite to that of the sub-pixels of corresponding color within adjacent arranging period; and the compensation photon sub-pixel row is a yellow sub-pixel row.

Wherein the sub-pixels is divided into a first base-color sub-pixel row, a second base-color sub-pixel row, a third base-color sub-pixel row, and a compensation photon sub-pixel row arranged periodically along a direction from the scanning lines toward another end in sequence, the driving voltage is respectively applied from the adjacent data lines located close to the scanning lines toward the first base-color sub-pixel row, the second base-color sub-pixel row, the third base-color sub-pixel row, and the compensation photon sub-pixel row, the driving voltage polarity of the compensation photon sub-pixel row is the same with that of the third base-color sub-pixel row within the same arranging period and is opposite to that of the first base-color sub-pixel row within the arranging period adjacent to the other end of the scanning line.

Wherein the driving voltage polarity of the compensation photon sub-pixel row is the same with that of the first base-color sub-pixel row within the same arranging period and is opposite to that of the second base-color sub-pixel row within the same arranging period.

Wherein the sub-pixels is divided into a first base-color sub-pixel row, a second base-color sub-pixel row, a third base-color sub-pixel row, and a compensation photon sub-pixel row arranged periodically along a direction from the scanning lines toward another end in sequence, wherein the driving voltage is applied from the data lines adjacent to the other end of the scanning lines toward the first base-color sub-pixel row, the second base-color sub-pixel row, the third base-color sub-pixel row, and the compensation photon sub-pixel row, the driving voltage polarity of the compensation photon sub-pixel row is opposite to that of the third base-color sub-pixel row within the same arranging period and is the same with that of the first base-color sub-pixel row within the arranging period adjacent to the other end of the scanning line.

Wherein the driving voltage polarity of the compensation photon sub-pixel row is opposite to that of the first base-color sub-pixel row within the same arranging period and is the same with that of the second base-color sub-pixel row within the same arranging period.

Wherein the sub-pixels is divided into a first base-color sub-pixel row, a second base-color sub-pixel row, a third base-color sub-pixel row, and a compensation photon sub-pixel row arranged periodically along a direction from the scanning lines toward another end in sequence, wherein the driving voltage is applied from the data lines adjacent to the scanning lines toward the first base-color sub-pixel row, the second base-color sub-pixel row, the third base-color sub-pixel row, and the compensation photon sub-pixel row, the driving voltage polarity of the compensation photon sub-pixel row is opposite to that of the first base-color sub-pixel row within the same arranging period and is the same with that of the third base-color sub-pixel row within the arranging period adjacent to the other end of the scanning line.

In another aspect, an array substrate of liquid crystal panels includes: a plurality of scanning lines arranged along a row direction, a plurality of data lines arranged along a column direction, and a plurality of sub-pixels arranged in a matrix defining by the scanning lines and the data lines, the scanning lines and the data lines correspond to the black matrixes of a color film substrate of the liquid crystal panel, the sub-pixels are divided into a plurality of sub-pixel rows of different colors arranged periodically along the column direction, wherein at least one sub-pixel row is a compensation photon sub-pixel row, within the same frame, a driving voltage polarity of two adjacent data lines of the compensation photon sub-pixel row is opposite to each other, and within the same frame, the driving voltage polarity of each of the sub-pixel rows within each arranging periods is opposite to that of the sub-pixels of corresponding color within adjacent arranging period.

Wherein within the same frame, the driving voltage polarity of each of the sub-pixel rows within each of the arranging periods is opposite to that of the sub-pixel rows having corresponding colors within the adjacent arranging periods.

Wherein the sub-pixels is divided into a first base-color sub-pixel row, a second base-color sub-pixel row, a third base-color sub-pixel row, and a compensation photon sub-pixel row arranged periodically along a direction from the scanning lines toward another end in sequence, the driving voltage is respectively applied from the adjacent data lines located close to the scanning lines toward the first base-color sub-pixel row, the second base-color sub-pixel row, the third base-color sub-pixel row, and the compensation photon sub-pixel row, the driving voltage polarity of the compensation photon sub-pixel row is the same with that of the third base-color sub-pixel row within the same arranging period and is opposite to that of the first base-color sub-pixel row within the arranging period adjacent to the other end of the scanning line.

Wherein the driving voltage polarity of the compensation photon sub-pixel row is the same with that of the first base-color sub-pixel row within the same arranging period and is opposite to that of the second base-color sub-pixel row within the same arranging period.

Wherein the first base-color sub-pixel row, the second base-color sub-pixel row, the third base-color sub-pixel row, and the compensation photon sub-pixel row are respectively a red sub-pixel row, a green sub-pixel row, a blue sub-pixel row, and a white sub-pixel row.

Wherein the sub-pixels is divided into a first base-color sub-pixel row, a second base-color sub-pixel row, a third base-color sub-pixel row, and a compensation photon sub-pixel row arranged periodically along a direction from the scanning lines toward another end in sequence, wherein the driving voltage is applied from the data lines adjacent to the other end of the scanning lines toward the first base-color sub-pixel row, the second base-color sub-pixel row, the third base-color sub-pixel row, and the compensation photon sub-pixel row, the driving voltage polarity of the compensation photon sub-pixel row is opposite to that of the third base-color sub-pixel row within the same arranging period and is the same with that of the first base-color sub-pixel row within the arranging period adjacent to the other end of the scanning line.

Wherein the driving voltage polarity of the compensation photon sub-pixel row is opposite to that of the first base-color sub-pixel row within the same arranging period and is the same with that of the second base-color sub-pixel row within the same arranging period.

Wherein the first base-color sub-pixel row, the second base-color sub-pixel row, the third base-color sub-pixel row, and the compensation photon sub-pixel row are respectively a red sub-pixel row, a green sub-pixel row, a blue sub-pixel row, and a white sub-pixel row.

Wherein the sub-pixels is divided into a first base-color sub-pixel row, a second base-color sub-pixel row, a third base-color sub-pixel row, and a compensation photon sub-pixel row arranged periodically along a direction from the scanning lines toward another end in sequence, wherein the driving voltage is applied from the data lines adjacent to the scanning lines toward the first base-color sub-pixel row, the second base-color sub-pixel row, the third base-color sub-pixel row, and the compensation photon sub-pixel row, the driving voltage polarity of the compensation photon sub-pixel row is opposite to that of the first base-color sub-pixel row within the same arranging period and is the same with that of the third base-color sub-pixel row within the arranging period adjacent to the other end of the scanning line.

Wherein the first base-color sub-pixel row, the second base-color sub-pixel row, the third base-color sub-pixel row, and the compensation photon sub-pixel row are respectively a red sub-pixel row, a green sub-pixel row, a blue sub-pixel row, and a white sub-pixel row.

In another aspect, a driving method of array substrates, the array substrate includes a plurality of scanning lines arranged along a row direction, a plurality of data lines arranged along a column direction, and a plurality of sub-pixels arranged in a matrix defining by the scanning lines and the data lines, the sub-pixels are divided into a plurality of sub-pixel rows of different colors arranged periodically along the column direction, wherein at least one sub-pixel row is a compensation photon sub-pixel row, the method includes: applying strobe signals toward the scanning lines in turn; applying driving voltage respectively toward the data lines, within the same frame, a driving voltage polarity of two adjacent data lines corresponding to the compensation photon sub-pixel row are opposite to each other.

Wherein the step of applying the driving voltage toward the data lines further includes, within the same frame, configuring the driving voltage polarity of each of the sub-pixel rows within each of the arranging periods to be opposite to that of the two adjacent data lines of the sub-pixel row having corresponding color.

In view of the above, the voltage coupling effect caused by two adjacent data lines toward the compensation photon sub-pixel row may be reduced by configuring the driving voltage polarity of the two adjacent data lines of the compensation photon sub-pixel row to be opposite to each other, which also reduces the impact toward the driving voltage of the compensation photon sub-pixel row. As such, the brightness change of the compensation photon sub-pixel row is decreased so as to enhance the image quality.

### BRIEF DESCRIPTION OF THE DRAWINGS

FIG. 1 is a schematic view of the pixel structure of one conventional array substrate.

FIG. 2 is a schematic view showing the brightness change of the array substrate of FIG. 1.

FIG. 3 is a schematic view of the array substrate in accordance with one embodiment.

FIG. 4 is a schematic view of the array substrate in accordance with another embodiment.

FIG. 5 is a schematic view of the array substrate in accordance with another embodiment.

FIG. 6 is a schematic view of the liquid crystal panel in accordance with one embodiment.

FIG. 7 is a flowchart of the driving method of the array substrate in accordance with one embodiment.

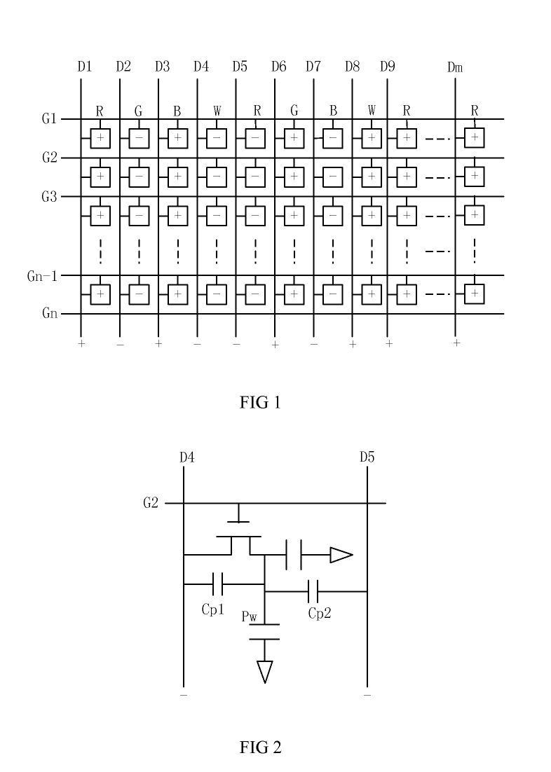

### DETAILED DESCRIPTION OF THE EMBODIMENTS

Embodiments of the invention will now be described more fully hereinafter with reference to the accompanying drawings, in which embodiments of the invention are shown.

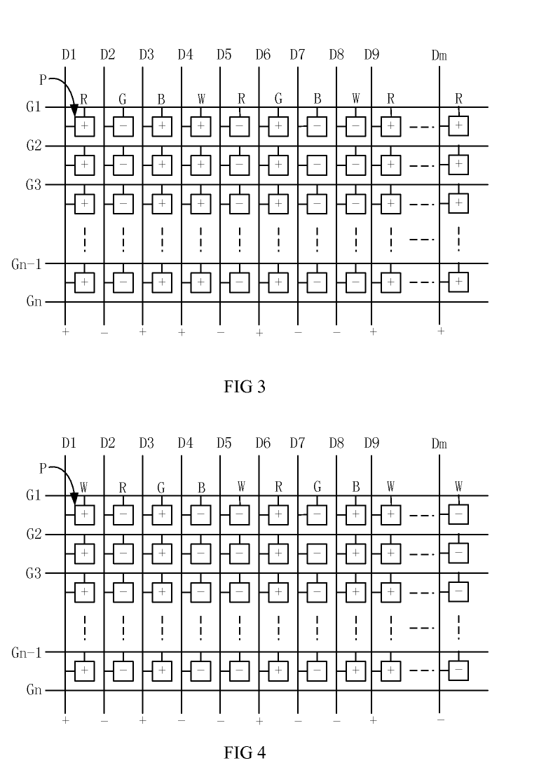

FIG. 3 is a schematic view of the array substrate in accordance with one embodiment. The array substrate may be the array substrate in the liquid crystal panel. The array substrate includes a plurality of scanning lines (G1-Gn) arranged along a row direction, wherein n is larger than or equal to one, a plurality of data lines (D1-Dn) arranged along a column direction, wherein m is larger than or equal to one, and a plurality of sub-pixels (P) defining a matrix by the scanning line (Gn) and the data line (Dm). Each of the sub-pixel (P) connects with one scanning line (Gn) and one data line (Dm). The scanning lines (G1-Gn) and the data lines (D1-Dm) are within the opaque area of the array substrate. That is, the scanning lines and the data lines correspond to the black matrixes of the color film substrate of the liquid crystal panel to enhance the transmission rate. The sub-pixels (P) are within the light transmission area of the array substrate to display images.

The sub-pixels (P) are divided into a plurality of sub-pixel rows of different colors arranged periodically along the column direction, wherein at least one sub-pixel row is a compensation photon sub-pixel row. As the brightness of the white light is higher, as shown in FIG. 3, the compensation photon sub-pixel row is the white photon sub-pixel row (W) emitting the white light for compensating the brightness of the images, which enhances the transmission rate.

Within the same frame, the driving voltage polarity of two adjacent data lines of the white photon sub-pixel row (W) is opposite to each other. It is to be noted that “within the same frame” relates to one scanning period. Within the scanning period, all of the scanning lines (G1-Gn) are scanned. The driving voltage polarity of the data line is in view of the common voltage. When the driving voltage of the data line is larger than that of the common voltage, the driving voltage polarity of the data line is positive. On the contrary, the polarity of the data line is negative.

In the embodiment, by configuring the driving voltage polarity of the two data lines adjacent to the white photon sub-pixel row (W), the capacitance coupling effect of the positive and the negative data lines toward the driving voltage of the white photon sub-pixel row (W) may be offset. As such, the change of the driving voltage of the white photon sub-pixel row (W) is small, and so does the brightness change. In this way, the impact toward the brightness of the images is decreased, and may not be easily detected by users eyes so as to enhance the image quality.

In addition, as shown in FIG. 3, the sub-pixels (P) is divided into a first base-color sub-pixel row (R), a second base-color sub-pixel row (G), a third base-color sub-pixel row (B), and a white photon sub-pixel row (W) arranged periodically from the scanning line (Gn) toward another end in sequence. The first base-color sub-pixel row (R), the second base-color sub-pixel row (G), and the third base-color sub-pixel row (B) are respectively the red sub-pixel row, the green sub-pixel row, and the blue sub-pixel row. In the embodiment, the end of the scanning line (Gn) is considered as the left end of the liquid crystal panel, and the other end is considered as the right end of the liquid crystal panel. It can be understood that the left end and the right end may be expressed by other ways.

The driving voltage is applied to the first base-color sub-pixel row (R), the second base-color sub-pixel row (G), the third base-color sub-pixel row (B), and the white photon sub-pixel row (W) from the adjacent data lines located closest to the scanning line (Gn). As shown in FIG. 3, the first base-color sub-pixel row (R), the second base-color sub-pixel row (G), the third base-color sub-pixel row (B) and the white photon sub-pixel row (W) are arranged from left to right in turn. The first base-color sub-pixel row (R), the second base-color sub-pixel row (G), the third base-color sub-pixel row (B), and the white photon sub-pixel row (W) have been applied with the driving voltage by the adjacent data lines located in the left side.

In order to reduce the horizontal crosstalk, within the same frame, the driving voltage polarity of each of the sub-pixel row within one arranging period is opposite to that of the sub-pixels of corresponding color within adjacent arranging period. Specifically, the driving voltage polarity of the first base-color sub-pixel row (R) within one arranging period is opposite to that of the first base-color sub-pixel row (R) within adjacent arranging period. The driving voltage polarity of the second base-color sub-pixel row (G) within one arranging period is opposite to that of the second base-color sub-pixel row (G) within adjacent arranging period. Thus, the impact of the driving voltage of the sub-pixels within two adjacent arranging period toward the common voltage may be offset to some extent. This reduces the coupling of the driving voltage of the sub-pixel row toward the common voltage, and thus may greatly reduce the horizontal crosstalk of the liquid crystal panel.

In the embodiment, the driving voltage polarity of the white photon sub-pixel row (W) is the same with the driving voltage polarity of the third base-color sub-pixel row (B) within the same arranging period. In addition, the driving voltage polarity of the white photon sub-pixel row (W) is opposite to that of the first base-color sub-pixel row (R) within the adjacent arranging period close to the right end of the liquid crystal panel such that the driving voltage polarity of the two adjacent data lines corresponding to the white photon sub-pixel row (W) are opposite.

In addition, the driving voltage polarity of the white photon sub-pixel row (W) is the same with that of the first base-color sub-pixel row (R) within the same arranging period, and is opposite to that of the second base-color sub-pixel row (G) within the same arranging period.

For instance, as shown in FIG. 3, within the same frame, the driving voltage polarity of the first base-color sub-pixel row (R), the second base-color sub-pixel row (G), the third base-color sub-pixel row (B) and the white photon sub-pixel row (W) within the same arranging period being respectively connected by the data lines D1, D2, D3, D4 are respectively positive, negative, positive, positive. The driving voltage polarity of the first base-color sub-pixel row (R), the second base-color sub-pixel row (G), the third base-color sub-pixel row (B) and the white photon sub-pixel row (W) within the same arranging period being respectively connected by the data lines D5, D6, D7, D8 are respectively negative, positive, negative and negative. In addition, the array substrate is driven by frame inversion driving method. After the first frame, within the next frame, the driving voltage polarity of the first base-color sub-pixel row (R), the second base-color sub-pixel row (G), the third base-color sub-pixel row (B) and the white photon sub-pixel row (W) within the same arranging period being respectively connected by the data lines D1, D2, D3, D4 are respectively negative, positive, negative, and negative. The driving voltage polarity of the first base-color sub-pixel row (R), the second base-color sub-pixel row (G), the third base-color sub-pixel row (B) and the white photon sub-pixel row (W) within the same arranging period being respectively connected by the data lines D5, D6, D7, D8 are respectively positive, negative, positive, and positive.

Thus, in the embodiment, the driving voltage polarity of the two adjacent data lines at two sides of the third base-color sub-pixel row (B) are the same. However, as the third base-color sub-pixel row (B) is the sub-pixel row of blue photon sub-pixel row emitting blue lights, the brightness of the third base-color sub-pixel row (B) is lower than the brightness of the white photon sub-pixel row (W). Thus, even the driving voltage has been changed by the two data lines having the same driving voltage polarity, the change can only slight impact the brightness of the images. Compared to the impact caused by the white photon sub-pixel row (W), human eyes are not capable of detecting such brightness change. Thus, compared with the conventional driving method, such configuration may reduce the vertical crosstalk together with the brightness change so as to enhance the image quality.

In other embodiments, the compensation photon sub-pixel row may be yellow photon sub-pixel row emitting yellow lights or photon sub-pixel row of other colors so as to compensate the brightness of the images. In addition, the first base-color sub-pixel row, the second base-color sub-pixel row, the third base-color sub-pixel row may be the sub-pixel row of other colors.

In the embodiments, the four sub-pixel rows including the first base-color sub-pixel row (R), the second base-color sub-pixel row (G), the third base-color sub-pixel row (B) and the white photon sub-pixel row (W), which is the compensation light, are arranged from one end of the scanning line (Gn) toward the other end. Referring to FIG. 4, in another example, the four sub-pixel rows including the white photon sub-pixel row (W), the first base-color sub-pixel row (R), the second base-color sub-pixel row (G) and the third base-color sub-pixel row (B) are arranged from one end of the scanning line (Gn) toward the other end.

As shown in FIG. 4, the sub-pixels (P) being arranged from one end of the scanning line (Gn) toward the other end may be divided into a plurality arranging periods adjacent to each other, and one arranging period includes the white photon sub-pixel row (W), the first base-color sub-pixel row (R), the second base-color sub-pixel row (G) and third base-color sub-pixel row (B), and the white photon sub-pixel row (W) is the compensation photon sub-pixel row. The driving voltage is applied from the adjacent data line (Dm), which is close to the scanning line (Gn), toward the white photon sub-pixel row (W), the first base-color sub-pixel row (R), the second base-color sub-pixel row (G) and the third base-color sub-pixel row (B).

The driving voltage polarity of the white photon sub-pixel row (W) is opposite to that of the first base-color sub-pixel row (R) within the same arranging period, and is the same with that of the third base-color sub-pixel row (B) of the arranging period adjacent to the scanning line (Gn). The driving voltage polarity of the white photon sub-pixel row (W) is the same with that of the second base-color sub-pixel row (G) within the same arranging period, and is opposite to that of the third base-color sub-pixel row (B) within the same arranging period. As shown in FIG. 4, within the same frame, the driving voltage polarity of the white photon sub-pixel row (W), the first base-color sub-pixel row (R), the second base-color sub-pixel row (G), and the third base-color sub-pixel row (B) are respectively negative, positive, negative and positive. The white photon sub-pixel row (W), the first base-color sub-pixel row (R), the second base-color sub-pixel row (G), and the third base-color sub-pixel row (B) within the arranging period adjacent to the scanning line (Gn) are respectively positive, negative, positive and negative.

Thus, the driving voltage polarity of two adjacent data lines of the white photon sub-pixel row (W) are opposite to each other, which reduces the impact of the two adjacent data lines toward the driving voltage of the white photon sub-pixel row (W). Thus, the changed driving voltage can only slight impact the brightness of the images, and such changed cannot be easily detected by human eyes, which enhances the image quality. In addition, the driving voltage polarity of the four sub-pixel rows within one arranging period is the same with conventional one. That is, the method only needs to configure the arrangement of the four sub-pixel rows without changing the driving method. As such, the driving voltage polarity of two adjacent data lines corresponding to the white photon sub-pixel row (W) are opposite to each other so as to decrease the brightness change of the images.

Referring to FIG. 5, in another embodiment, the sub-pixels (P) includes a plurality of periodic arranging periods from one end of the liquid crystal panel close to the scanning line (Gn) toward the other end of the liquid crystal panel. The arranging periods are adjacent to each other and each of the arranging period includes the first base-color sub-pixel row (R), the second base-color sub-pixel row (G), the third base-color sub-pixel row (B), and the white photon sub-pixel row (W) operating as the compensation photon sub-pixel row. The first base-color sub-pixel row (R), the second base-color sub-pixel row (G), and the third base-color sub-pixel row (B) are respectively red photo sub-pixel row, green photo sub-pixel row, and blue photo sub-pixel row. In the embodiment, the end of the scanning line (Gn) is considered as the left end of the liquid crystal panel, and the other end is considered as the right end of the liquid crystal panel. It can be understood that the left end and the right end may be expressed by other ways.

The driving voltage is applied to the first base-color sub-pixel row (R), the second base-color sub-pixel row (G), the third base-color sub-pixel row (B), and the white photon sub-pixel row (W) from the adjacent data lines located closest to the scanning line (Gn). As shown in FIG. 5, the first base-color sub-pixel row (R), the second base-color sub-pixel row (G), the third base-color sub-pixel row (B) and the white photon sub-pixel row (W) are arranged from left to right in turn. The first base-color sub-pixel row (R), the second base-color sub-pixel row (G), the third base-color sub-pixel row (B), and the white photon sub-pixel row (W) have been applied with the driving voltage by the adjacent data lines located in the right side.

In order to reduce the horizontal crosstalk, within the same frame, the driving voltage polarity of the each of the sub-pixel row within one arranging period is opposite to that of the sub-pixels of corresponding color within adjacent arranging period. Specifically, the driving voltage polarity of the first base-color sub-pixel row (R) within one arranging period is opposite to that of the first base-color sub-pixel row (R) within adjacent arranging period. The driving voltage polarity of the second base-color sub-pixel row (G) within one arranging period is opposite to that of the second base-color sub-pixel row (G) within adjacent arranging period. Thus, the impact of the driving voltage of the sub-pixels within two adjacent arranging period toward the common voltage may be offset to some extent. This reduces the coupling of the driving voltage of the sub-pixel row toward the common voltage, and thus may greatly reduce the horizontal crosstalk of the liquid crystal panel.

In the embodiment, the driving voltage polarity of the white photon sub-pixel row (W) is opposite to the driving voltage polarity of the third base-color sub-pixel row (B) within the same arranging period. In addition, the driving voltage polarity of the white photon sub-pixel row (W) is the same with that of the first base-color sub-pixel row (R) within the adjacent arranging period close to the right end of the liquid crystal panel such that the driving voltage polarity of the two adjacent data lines corresponding to the white photon sub-pixel row (W) are opposite.

In addition, the driving voltage polarity of the white photon sub-pixel row (W) is the opposite to that of the first base-color sub-pixel row (R) within the same arranging period, and is the same with that of the second base-color sub-pixel row (G) within the same arranging period.

For instance, as shown in FIG. 5, within the same frame, the driving voltage polarity of the first base-color sub-pixel row (R), the second base-color sub-pixel row (G), the third base-color sub-pixel row (B) and the white photon sub-pixel row (W) within the same arranging period being respectively connected by the data lines D1, D2, D3, D4 are respectively positive, negative, positive, positive. The driving voltage polarity of the first base-color sub-pixel row (R), the second base-color sub-pixel row (G), the third base-color sub-pixel row (B) and the white photon sub-pixel row (W) within the same arranging period being respectively connected by the data lines D5, D6, D7, D8 are respectively negative, positive, negative and positive.

Thus, in the embodiment, the driving voltage polarity of the two adjacent data lines at two sides of the first base-color sub-pixel row (R) are the same. However, as the first base-color sub-pixel row (R) is the sub-pixel row of blue red sub-pixel row emitting red lights, the brightness of the first base-color sub-pixel row (R) is lower than the brightness of the white photon sub-pixel row (W). Thus, even the driving voltage has been changed by the two data lines having the same driving voltage polarity, the change can only slight impact the brightness of the images. Compared to the impact caused by the white photon sub-pixel row (W), human eyes are not capable of detecting such brightness change. Thus, compared with the conventional driving method, such configuration may reduce the vertical crosstalk together with the brightness change so as to enhance the image quality.

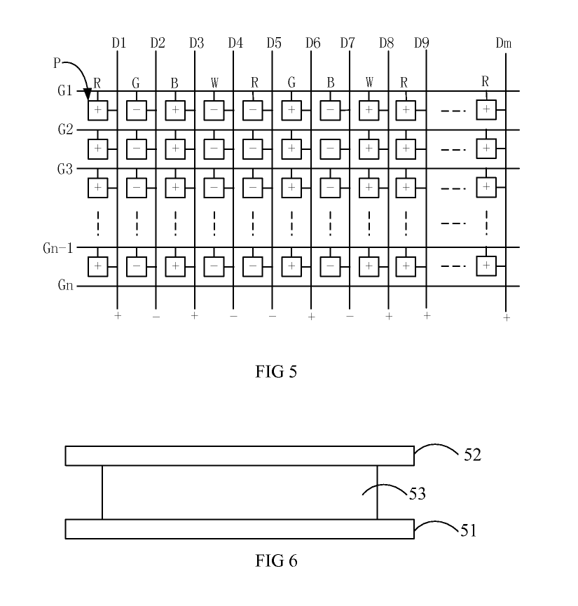

Referring to FIG. 6, the liquid crystal panel includes the array substrate 51, the color filter substrate 52, and a liquid crystal layer 53 between the array substrate 51 and the color filter substrate 52. The structure and the driving method of the array substrate 51 may be the same with any one of the embodiments.

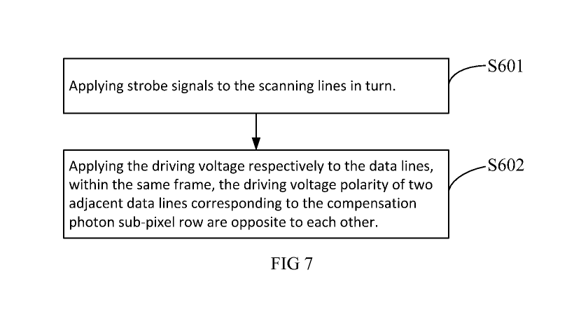

FIG. 7 is a flowchart of the driving method of the array substrate in accordance with one embodiment. The array substrate may be the array substrate in any one of the above embodiments. Taking the array substrate in FIG. 3 as one example, the array substrate includes a plurality of scanning lines (G1-Gn) arranged along a row direction, a plurality of data lines (D1-Dn) arranged along a column direction, and a plurality of sub-pixels (P) defining a matrix by the scanning line (Gn) and the data line (Dm). The sub-pixels (P) are divided into a plurality of sub-pixel rows of different colors arranged periodically along the column direction, wherein one sub-pixel row is a compensation photon sub-pixel row. The compensation photon sub-pixel row is the white photon sub-pixel row (W). The method includes the following steps.

In block S601, strobe signals are applied to the scanning lines in turn. In the embodiment, the columns are scanned in turn so as to apply the scanning signals toward the scanning lines (G1-Gn) in turn. As such, the sub-pixel (P) on the selected scanning lines are driven in turn.

In step S602, the driving voltage is applied respectively to the data lines. Within the same frame, the driving voltage polarity of two adjacent data lines corresponding to the compensation photon sub-pixel row are opposite to each other.

In the embodiment, by configuring the driving voltage polarity of two adjacent data lines corresponding to the compensation photon sub-pixel row to be opposite to each other, the capacitance coupling effect of the positive and the negative data lines toward the driving voltage of the white photon sub-pixel row (W) may be offset to some extent. As such, the change of the driving voltage of the white photon sub-pixel row (W) is small, and so does the brightness change. In this way, the impact toward the brightness of the images is decreased, and may not be easily detected by users eyes so as to enhance the image quality.

In addition, the step of applying the driving voltage toward the data lines includes, within the same frame, configuring the driving voltage polarity of each of the sub-pixel row within each of the arranging periods to be opposite to that of the two adjacent data lines of the sub-pixel row having corresponding color. Thus, the impact of the driving voltage of the sub-pixels within two adjacent arranging period toward the common voltage may be offset to some extent. This reduces the coupling of the driving voltage of the sub-pixel row toward the common voltage, and thus may greatly reduce the horizontal crosstalk of the liquid crystal panel.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An array substrate of liquid crystal panels, comprising:
a plurality of scanning lines arranged along a row direction, a plurality of data lines arranged along a column direction, and a plurality of sub-pixels arranged in a matrix defining by the scanning lines and the data lines, the scanning lines and the data lines correspond to the black matrixes of a color film substrate of the liquid crystal panel, the sub-pixels are divided into a plurality of sub-pixel rows of different colors arranged periodically along the column direction, wherein at least one sub-pixel row is a compensation photon sub-pixel row, within the same frame, a driving voltage polarity of two adjacent data lines of the compensation photon sub-pixel row is opposite to each other, and within the same frame, the driving voltage polarity of each of the sub-pixel rows within each arranging periods is opposite to that of the sub-pixels of corresponding color within adjacent arranging period; and
the compensation photon sub-pixel row is a yellow sub-pixel row.

2. The array substrate claimed in claim 1, wherein the sub-pixels is divided into a first base-color sub-pixel row, a second base-color sub-pixel row, a third base-color sub-pixel row, and a compensation photon sub-pixel row arranged periodically along a direction from the scanning lines toward another end in sequence, the driving voltage is respectively applied from the adjacent data lines located close to the scanning lines toward the first base-color sub-pixel row, the second base-color sub-pixel row, the third base-color sub-pixel row, and the compensation photon sub-pixel row, the driving voltage polarity of the compensation photon sub-pixel row is the same with that of the third base-color sub-pixel row within the same arranging period and is opposite to that of the first base-color sub-pixel row within the arranging period adjacent to the other end of the scanning line.

3. The array substrate claimed in claim 2, wherein the driving voltage polarity of the compensation photon sub-pixel row is the same with that of the first base-color sub-pixel row within the same arranging period and is opposite to that of the second base-color sub-pixel row within the same arranging period.

4. The array substrate claimed in claim 1, wherein the sub-pixels is divided into a first base-color sub-pixel row, a second base-color sub-pixel row, a third base-color sub-pixel row, and a compensation photon sub-pixel row arranged periodically along a direction from the scanning lines toward another end in sequence, wherein the driving voltage is applied from the data lines adjacent to the other end of the scanning lines toward the first base-color sub-pixel row, the second base-color sub-pixel row, the third base-color sub-pixel row, and the compensation photon sub-pixel row, the driving voltage polarity of the compensation photon sub-pixel row is opposite to that of the third base-color sub-pixel row within the same arranging period and is the same with that of the first base-color sub-pixel row within the arranging period adjacent to the other end of the scanning line.

5. The array substrate claimed in claim 4, wherein the driving voltage polarity of the compensation photon sub-pixel row is opposite to that of the first base-color sub-pixel row within the same arranging period and is the same with that of the second base-color sub-pixel row within the same arranging period.

6. The array substrate claimed in claim 1, wherein the sub-pixels is divided into a first base-color sub-pixel row, a second base-color sub-pixel row, a third base-color sub-pixel row, and a compensation photon sub-pixel row arranged periodically along a direction from the scanning lines toward another end in sequence, wherein the driving voltage is applied from the data lines adjacent to the scanning lines toward the first base-color sub-pixel row, the second base-color sub-pixel row, the third base-color sub-pixel row, and the compensation photon sub-pixel row, the driving voltage polarity of the compensation photon sub-pixel row is opposite to that of the first base-color sub-pixel row within the same arranging period and is the same with that of the third base-color sub-pixel row within the arranging period adjacent to the other end of the scanning line.

7. An array substrate of liquid crystal panels, comprising:
a plurality of scanning lines arranged along a row direction, a plurality of data lines arranged along a column direction, and a plurality of sub-pixels arranged in a matrix defining by the scanning lines and the data lines, the scanning lines and the data lines correspond to the black matrixes of a color film substrate of the liquid crystal panel, the sub-pixels are divided into a plurality of sub-pixel rows of different colors arranged periodically along the column direction, wherein at least one sub-pixel row is a compensation photon sub-pixel row, within the same frame, a driving voltage polarity of two adjacent data lines of the compensation photon sub-pixel row is opposite to each other, and within the same frame, the driving voltage polarity of each of the sub-pixel rows within each arranging periods is opposite to that of the sub-pixels of corresponding color within adjacent arranging period.

8. The array substrate claimed in claim 7, wherein within the same frame, the driving voltage polarity of each of the sub-pixel rows within each of the arranging periods is opposite to that of the sub-pixel rows having corresponding colors within the adjacent arranging periods.

9. The array substrate claimed in claim 8, wherein the sub-pixels is divided into a first base-color sub-pixel row, a second base-color sub-pixel row, a third base-color sub-pixel row, and a compensation photon sub-pixel row arranged periodically along a direction from the scanning lines toward another end in sequence, the driving voltage is respectively applied from the adjacent data lines located close to the scanning lines toward the first base-color sub-pixel row, the second base-color sub-pixel row, the third base-color sub-pixel row, and the compensation photon sub-pixel row, the driving voltage polarity of the compensation photon sub-pixel row is the same with that of the third base-color sub-pixel row within the same arranging period and is opposite to that of the first base-color sub-pixel row within the arranging period adjacent to the other end of the scanning line.

10. The array substrate claimed in claim 9, wherein the driving voltage polarity of the compensation photon sub-pixel row is the same with that of the first base-color sub-pixel row within the same arranging period and is opposite to that of the second base-color sub-pixel row within the same arranging period.

11. The array substrate claimed in claim 9, wherein the first base-color sub-pixel row, the second base-color sub-pixel row, the third base-color sub-pixel row, and the compensation photon sub-pixel row are respectively a red sub-pixel row, a green sub-pixel row, a blue sub-pixel row, and a white sub-pixel row.

12. The array substrate claimed in claim 8, wherein the sub-pixels is divided into a first base-color sub-pixel row, a second base-color sub-pixel row, a third base-color sub-pixel row, and a compensation photon sub-pixel row arranged periodically along a direction from the scanning lines toward another end in sequence, wherein the driving voltage is applied from the data lines adjacent to the other end of the scanning lines toward the first base-color sub-pixel row, the second base-color sub-pixel row, the third base-color sub-pixel row, and the compensation photon sub-pixel row, the driving voltage polarity of the compensation photon sub-pixel row is opposite to that of the third base-color sub-pixel row within the same arranging period and is the same with that of the first base-color sub-pixel row within the arranging period adjacent to the other end of the scanning line.

13. The array substrate claimed in claim 12, wherein the driving voltage polarity of the compensation photon sub-pixel row is opposite to that of the first base-color sub-pixel row within the same arranging period and is the same with that of the second base-color sub-pixel row within the same arranging period.

14. The array substrate claimed in claim 12, wherein the first base-color sub-pixel row, the second base-color sub-pixel row, the third base-color sub-pixel row, and the compensation photon sub-pixel row are respectively a red sub-pixel row, a green sub-pixel row, a blue sub-pixel row, and a white sub-pixel row.

15. The array substrate claimed in claim 8, wherein the sub-pixels is divided into a first base-color sub-pixel row, a second base-color sub-pixel row, a third base-color sub-pixel row, and a compensation photon sub-pixel row arranged periodically along a direction from the scanning lines toward another end in sequence, wherein the driving voltage is applied from the data lines adjacent to the scanning lines toward the first base-color sub-pixel row, the second base-color sub-pixel row, the third base-color sub-pixel row, and the compensation photon sub-pixel row, the driving voltage polarity of the compensation photon sub-pixel row is opposite to that of the first base-color sub-pixel row within the same arranging period and is the same with that of the third base-color sub-pixel row within the arranging period adjacent to the other end of the scanning line.

16. The array substrate claimed in claim 15, wherein the first base-color sub-pixel row, the second base-color sub-pixel row, the third base-color sub-pixel row, and the compensation photon sub-pixel row are respectively a red sub-pixel row, a green sub-pixel row, a blue sub-pixel row, and a white sub-pixel row.

17. A driving method of array substrates, the array substrate comprises a plurality of scanning lines arranged along a row direction, a plurality of data lines arranged along a column direction, and a plurality of sub-pixels arranged in a matrix defining by the scanning lines and the data lines, the sub-pixels are divided into a plurality of sub-pixel rows of different colors arranged periodically along the column direction, wherein at least one sub-pixel row is a compensation photon sub-pixel row, the method comprising:
applying strobe signals toward the scanning lines in turn;
applying driving voltage respectively toward the data lines, within the same frame, a driving voltage polarity of two adjacent data lines corresponding to the compensation photon sub-pixel row are opposite to each other.

18. The driving method as claimed in claim 17, wherein the step of applying the driving voltage toward the data lines further comprises, within the same frame, configuring the driving voltage polarity of each of the sub-pixel rows within each of the arranging periods to be opposite to that of the two adjacent data lines of the sub-pixel row having corresponding color.
